(19) United States
(12) Patent Application Publication
(10) Pub. No.: US 2012/0296697 A1
(43) Pub. Date: Nov. 22, 2012

(54) SYSTEMS AND METHODS FOR AUTOMATED REAL TIME E-COMMERCE MARKETING ACTIVITIES

(76) Inventor: Amit Kumar, San Jose, CA (US)

(21) Appl. No.: 13/227,380

(22) Filed: Sep. 7, 2011

Related U.S. Application Data
(63) Continuation-in-part of application No. 13/181,381, filed on Jul. 12, 2011.
(60) Provisional application No. 61/487,237, filed on May 17, 2011.

(51) Int. Cl. G06Q 10/00; G06Q 30/00

(52) U.S. Cl. 705/7.29

(57) ABSTRACT

Systems and methods for e-commerce marketing activities are provided via an analytics server, which provides real-time information concerning customer visits to an e-commerce Website to a merchant that operates the Website, for example via a dashboard or other user interface. The real-time information allows the analytics system and merchant to monitor and optionally interact with customers visiting the Website, for example by sending instructions for advertisements or adjusting prices in response to consumer activity. Real-time telemetry concerning the customer visits is provided to the analytics server, which then presents the information in meaningful fashions via the dashboard or user interfaces for review by the merchant. Merchant responses to the information is facilitated via deal engines, recommendation engines, marketing engines, and other components, which may operate according to customized rule sets to implement key word bidding, advertisements, promotions, price adjustments, among other things.

### RELATED APPLICATIONS

This application is a continuation-in-part and claims priority to U.S. application Ser. No. 13/181,318, filed Jul. 12, 2011 and claims priority to U.S. Provisional Application No. 61/487,237, filed May 17, 2011 the entire contents of which are incorporated herein by reference.

### FIELD OF THE INVENTION

The present invention relates generally to the field of e-commerce systems and methods, and in particular to real-time systems and methods for marketing and advertising products online.

### BACKGROUND

E-commerce, which generally refers to commercial activities online, is an area that is rapidly increasing in popularity as more and more customers purchase consumer items from Web sites rather the visit physical stores. There are several e-commerce Web sites that are devoted to commercial activities. For example, virtual stores such as Amazon™ have sophisticated Web sites that offer a wide variety of products for sale to consumers. Other Web sites provide more limited sets of specialty items and still others cater to business customers as opposed to general consumers. Some Web-based stores have physical world counterparts, but many do not. Irrespective of whether the Web-based stores sell to consumers or business or whether they are extensions of physical world stores or not, virtually all Web-based store owners have an interest in understanding who is visiting their Web site and what activities those visitors are engaged in during such visits.

This need for information regarding Web site visitors has spawned the industry of Web analytics. Broadly speaking, Web analytics may be regarded as the measurement, collection, analysis and reporting of data for purposes of understanding Web site usage. Such analytics are also used in connection with business and market research. Many Web hosting providers, such as Google™, Yahoo!® and others, offer this kind of analytical information to their subscribers in connection with sites hosted for those subscribers. In particular, on-site Web analytics provide a Web site owner/operator with information regarding actual Web site visitor activities, but usually this is provided in the form of a compilation of historical information over various time periods/visits.

While somewhat useful, historical information provides only an after-the-fact view of visitor behaviors and has limited benefit for the Web site owner/operator. However, unlike real world physical stores, the Web site owner (or merchant) providing goods and services online has little access to real-time data in order to effectively market or discount products or bid on search terms in response to consumer trends. Large businesses typically have teams of employees that mine data on consumer trends, popular products, competitor products and pricing, etc. Business are then able to use this information to manually change their product offerings or prices online. Also, large businesses typically have marketing departments that bid for search terms relevant to that company's business or on popular search terms in response to consumer trends. A “search term” as generally understood by one of ordinary skill in art is a word or phrase that is used in a search request which then causes a search engine to display results based on the input of the search term.

A small business merchant may not necessarily have the advantage of a marketing department or even a marketing person that can review and respond to volumes of data on consumer activity from the merchant's website. It can be a tedious, expensive and time consuming process to review which product pages are popular, how many consumers are putting products into their shopping cart, which prices are the optimal prices, and so on. Also, a merchant of a real world store can monitor the traffic of his store at any hour and check the inventory as supply and demand for particular products increases or decreases. Traditional e-commerce Websites do not provide the ability for merchants to monitor the trends, patterns or behavior of customers and react to customer demands and consumer trends in real-time, for example, by changing their marketing strategy in response to real-time data.

### SUMMARY OF THE INVENTION

An embodiment of the invention includes a real-time e-commerce system, comprising an analytics system with an analytics database coupled to said analytics system; an e-commerce Website capable of communicating over a network with said analytics system; wherein said e-commerce Website includes analytics software; a merchant administrator client communicating over said network with said analytics system, wherein said merchant administrator client is capable of receiving analytics pages from said analytics system; a plurality of consumer client computers communicating with said e-commerce Website, wherein said clients are capable of displaying e-commerce Web pages to said users of said consumer client computers.

Another embodiment of the invention includes an analytics system, comprising: an analytics server for communicating with a e-commerce Website in real time; a rule engine for generating rules for the e-commerce Website based on a real time analysis of user actions; a deal engine for generating promotions for a particular user of said e-commerce Website, wherein said deals are based on a particular user's actions; a recommendation engine for generating recommendations to user's of said e-commerce Website based upon selections or preferences of said user; a front end server for communicating with said e-commerce Website; a marketing engine for effecting real-time marketing decisions; and a merchant dashboard engine for generating real-time analytics pages to said merchant on the activities of the user's of said e-commerce Website.

Another embodiment of the invention includes a real-time e-commerce system for marketing ads, key words or search terms bids based on real time analytics; wherein said system includes an e-commerce website with a plurality of customers accessing web page on said e-commerce website; an analytics system including an analytics engine communicatively coupled to said e-commerce website for processing real time consumer data from e-commerce website; a rule engine for storing and generating marketing rules based on consumer activity; a marketing engine for bidding on key words, search terms or ads; and one or more search engines or search term providers communicatively coupled to said analytics system; wherein the marketing engine sends instructions to bid on key words, search terms or ads to said search term providers based on real time analytics and rules; and a merchant administrator communicatively coupled to said analytics system.

In yet another embodiment of the invention, a computer-implemented automated method for bidding on search terms, key words or ads is disclosed, including the steps of: setting one or more marketing rules; registering customer activity at an e-commerce website; analyzing customer activity on e-commerce website; triggering a marketing rule by customer activity on the e-commerce website; instructing the marketing engine to make a marketing decision based on triggering of said rule; initiating a communication with a search term provider or search engine; bidding on a search term, key word or ad with said search term provider or search engine.

In another embodiment of the invention, a computer implemented method of generating an ad on a merchant's e-commerce website is disclosed, including the steps of gathering real-time consumer activity at an analytics engine; triggering a rule based on real-time consumer activity; generating an marketing recommendation to a merchant; displaying a marketing recommendation to a merchant; receiving instructions from said merchant regarding said marketing recommendation at said marketing engine; generating an ad; sending an ad to an e-commerce website.

Further disclosed herein is an automated method for adjusting a price at an e-commerce website, including the steps of: registering customer activity at an analytics engine; triggering a rule based on said customer activity; providing a rule to marketing engine to effect a pricing decision; generating a price instruction based on said rule; sending a new or adjusted price to the e-commerce website.

In other embodiments of the invention, the merchant administrator can make price adjustments by interacting with the analytics system.

In one embodiment of the invention, a cookie is placed on a customer computer for transmitting information on customer actions on a Web site to an analytics server.

Another embodiment of the invention includes a method for transmitting real time analytics to a merchant, wherein said analytics includes customer activity on web pages viewed by customers, products browed by customers, and product purchased by customers, including a display of graphical information showing consumer visiting, browsing and purchasing activity, wherein said information is provided to effect one or more marketing features for a merchant's e-commerce website.

It will be appreciated that the invention is not limited to the embodiments described herein. Although the invention has been described with reference to particular embodiments, the description is only an example of the invention's application and should not be taken as a limitation. Various adaptations and combinations of features of the embodiments disclosed are within the scope of the invention as defined by the claims. It should also be noted that embodiments of the present invention have been described with references to various software and hardware components, some of which are depicted in the exemplary figures. One of ordinary skill in the art will recognize that modern distributed computing system allow software and/or hardware components to reside in different locations, servers, clients and/or hardware or firmware components without limiting the location or function of the software, firmware or hardware components as described with reference to the exemplary embodiments and figures.

### BRIEF DESCRIPTION OF THE DRAWINGS

The present invention will be more fully understood from the following detailed description thereof, taken together with the accompanying drawings, in which:

FIGS. 1 and 2 are examples of computer architectures for computer systems configured in accordance with embodiments of the present invention.

FIG. 3 illustrates components of a network architecture in which embodiments of the present invention may be implemented.

FIG. 4 illustrates the components of the analytics systems according to embodiments of the invention.

FIG. 5 is an example of real-time marketing system according to embodiments of the present invention.

FIG. 6 is a flow diagram of a method for bidding on search terms or advertisements according to embodiments of the present invention.

FIG. 7 is a flow diagram depicting a method for effecting real-time marketing decisions in an e-commerce system according to embodiments of the present invention.

FIG. 8 is a flow diagram depicting an automated method for generating an advertisement in an e-commerce system according to embodiments of the invention.

FIGS. 9-10 illustrate examples of user interfaces for real time Web analytics information in accordance with various embodiments of the present invention.

### DETAILED DESCRIPTION

Embodiments of the present invention relate to real-time e-commerce systems and methods for monitoring customer activity online and marketing and effecting marketing decisions in real-time.

The present inventors have recognized that historical Web analytic information does not afford a Web site owner/operator opportunities for direct and meaningful interaction with visitors to the Web site. For example, reliance on only historical information does not afford the owner/operator a chance to influence a purchase decision of a Web site visitor in real time. Nor does the historical information permit an owner/operator opportunities to react to market trends, bid on search terms, generate advertisements or change the price of goods in real-time in response to real-time consumer activity on an e-commerce website. Accordingly, the present inventors have recognized a need for providing systems and methods to enable Web site operators to interact with customers in real time, monitor virtual store activities in real-time, and make marketing decisions such as bidding on search terms, generate advertisements or changing the price or offerings of goods in an e-commerce website in relation to real-time consumer activity data that is displayed to a merchant in user interfaces.

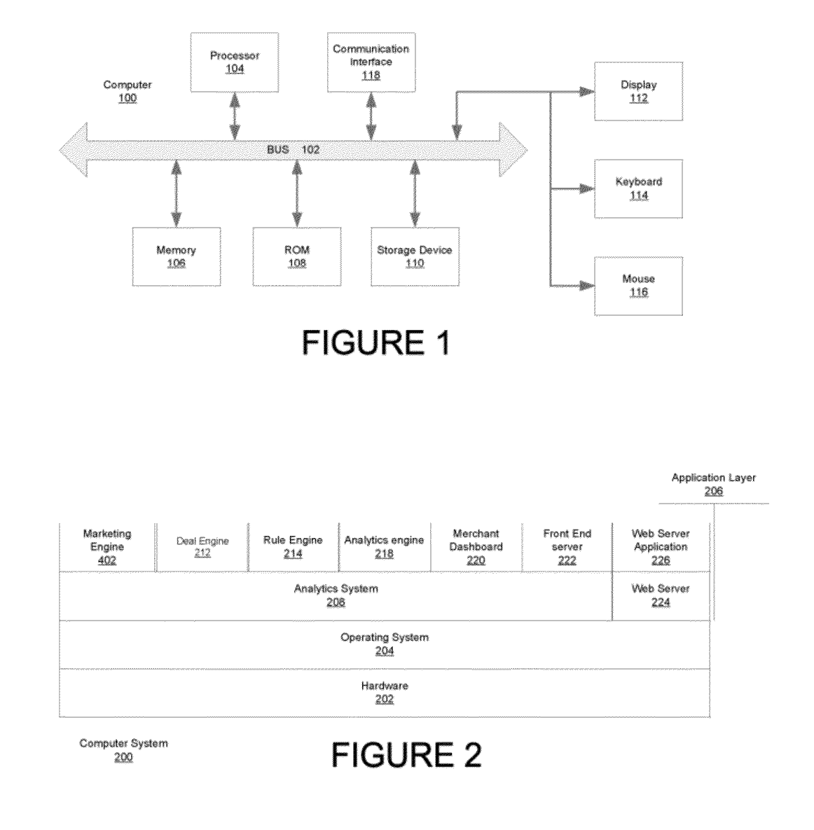

In various embodiments of the present invention, owners and operators of e-commerce Websites (hereinafter “merchants”) are provided access to an e-commerce analytics system which allows these merchants to view the activities of their customers as those customers are interacting with an online storefront through a merchant dashboard and, optionally, influence purchasing decisions of customers through interaction with the customers. The merchant dashboard is made accessible through a real-time analytics system via one or more computer networks. The analytics system can monitor the activities of individual customers and Web browsers that enter an online e-commerce Website and then report the activities of individual customers to the merchant in real-time. The merchant, who is also connected to the network, can monitor the real-time activities of the customers via the merchant dashboard (which may include one or more user interface screens) that provides detailed information concerning the customers visiting the merchant's Website and the activities of those customers. The analytics system also has the ability to provide the merchant real-time information on the prices, supply and demand of various products and services on other e-commerce Websites, or even physical stores, so the merchant can react in real time to decide whether to adjust the prices of products and services to meet market demands and/or provide customers visiting his/her online store special promotions and deals. Embodiments of the present invention are discussed below with reference to FIGS. 1-10.

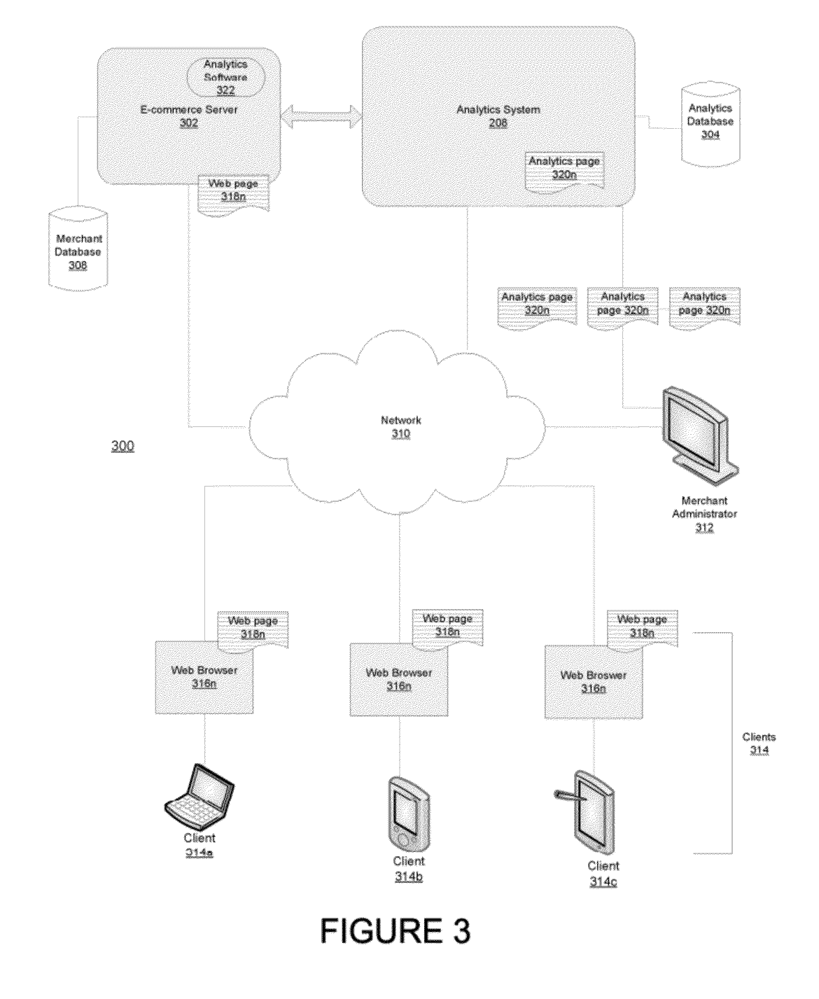

FIG. 1 illustrates an example of a computer system 100 on which any of the methods and systems of various embodiments of the present invention may be implemented. Computer system 100 may represent any of the computer systems discussed in connection with FIGS. 3-5 and, in particular, may represent a server, client or other computer system upon which e-commerce servers, Websites, Web browsers and/or Web analytic applications may be instantiated. Computer system 100 includes a bus 102 or other communication mechanism for communicating information, and a processor 104 coupled with the bus 102 for processing information. Computer system 100 also includes a main memory 106, such as a RAM or other dynamic storage device, coupled to the bus 102 for storing information and instructions (such as instructions for e-commerce rules and promotions) to be executed by processor 104. Main memory 106 also may be used for storing temporary variables or other intermediate information during execution of instructions to be executed by processor 104. Computer system 100 further includes a ROM 108 or other static storage device coupled to the bus 102 for storing static information and instructions for the processor 104. A storage device 110, such as a hard disk, is provided and coupled to the bus 102 for storing information and instructions (such as computer readable instructions comprising the Web analytics engines, customer information, Web server, and user interfaces for the merchant dashboard).

Computer system 100 may be coupled via the bus 102 to a display 112 for displaying information to a user, however, in the case of servers such a display may not be present and all administration of the server may be via remote clients. Likewise, input device 114, including alphanumeric and other keys, may be coupled to the bus 102 for communicating information and command selections to the processor 104, but such a device may not be present in server configurations. Another type of user input device is cursor control device 116, such as a mouse, a trackball, or cursor direction keys for communicating direction information and command selections to processor 104 and for controlling cursor movement on the display 112. Such an input device may or may not be present in a server configuration.

Computer system 100 also includes a communication interface 118 coupled to the bus 102. Communication interface 118 provides for two-way, wired and/or wireless data communication to/from computer system 100, for example, via a local area network (LAN) or other network, including the Internet. Communication interface 118 sends and receives electrical, electromagnetic or optical signals which carry digital data streams representing various types of information and instructions. For example, two or more computer systems 100 may be networked together in a conventional manner with each using a respective communication interface 118.

It will be appreciated that the merchant administrator 312, clients 314a-314c, Website e-commerce server 302, analytics system 208, and database 304 and 308 depicted in FIG. 3, can be implemented in computer system 100.

The various databases described herein are computer-based record keeping systems. Stated differently, these databases are each a combination of computer hardware and software that act together to allow for the storage and retrieval of information (data). Accordingly, they may resemble computer system 100, and are often characterized by having storage mediums capable of accommodating significant amounts of information.

FIG. 2 illustrates a computer system 200 from the point of view of its software architecture, according to embodiments of the invention. Computer system 200 may be a server or a group of servers or computers. The various hardware components of computer system 200 are represented as a hardware layer 202. An operating system 204 abstracts the hardware layer and acts as a host for various applications 208-224 and 402, that run on computer system 200. In the case of analytics system 208, the operating system acts as a host for an analytics system 208 which communicates with merchant administrators 312 and e-commerce server 302.

The computer system may also include Web server 224. For Web server 224 the operating system may host a Web server application 226, which provides access for the client computers via Web browsers. In the case of a client system, the operating system acts as a host for a Web browser application 316. The e-commerce server 302 and e-commerce Website 406 may run on Web server 224. In one embodiment the e-commerce server is remote to the analytics system and operates on a different group of computer systems. In another embodiment, the e-commerce system may include the analytics system 208. One or more Web servers may operate as part of analytics system 208 and Website e-commerce server 302. The Web server(s) and e-commerce server 302 may be implemented in computer systems similar to computer systems 100 or 200.

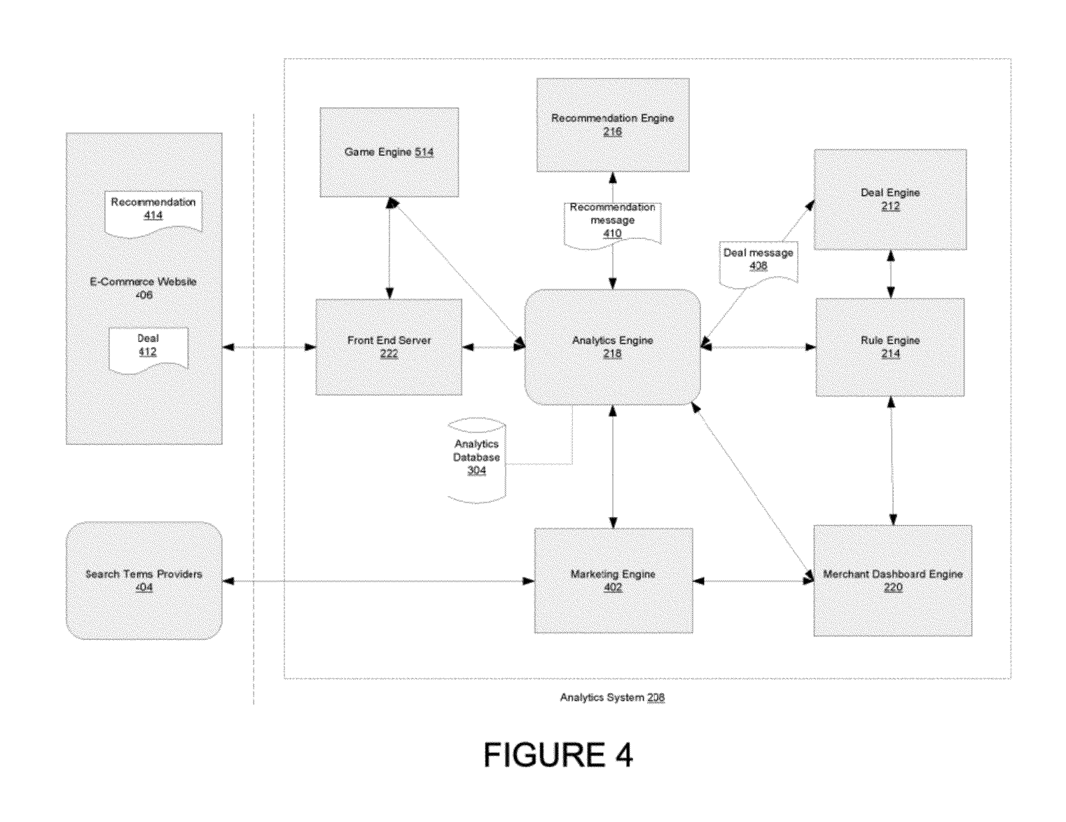

The analytics system 208 (depicted in greater detail in FIG. 4) comprises various software and/or firmware modules, including the deal engine 212, the rule engine 214, the recommendation engine 216, analytics engine 218, merchant dashboard 220 and front end server 222. It will be appreciated that the analytics system and the various applications 212-226 can reside on a single server, or a group of servers or computers at various locations on a network. The applications 208-222 and 402 are explained in greater detail with reference to FIG. 4 below.

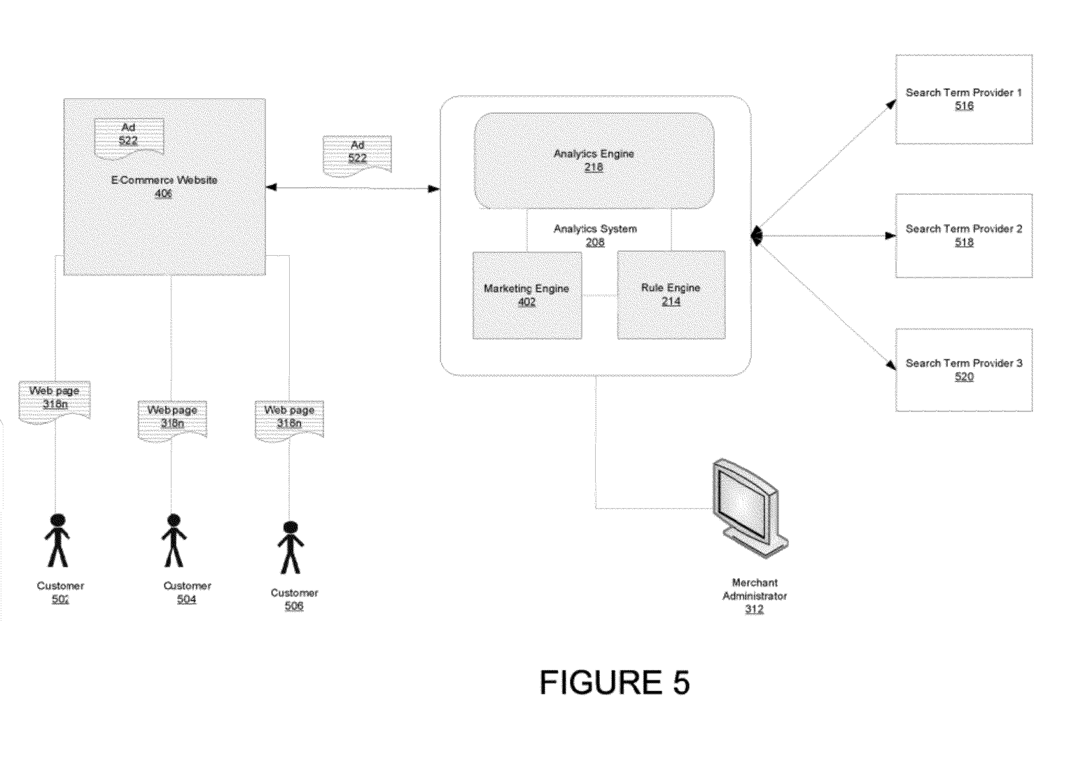

To better understand the context in which real-time analytics may be employed, consider system 300 illustrated in FIG. 3. Additional details of various components of this system are included in FIGS. 4 and 5.

Included in system 300 are e-commerce servers 302, each hosting one or more e-commerce Web sites. Each Web site may include one or more Web pages 318n. As mentioned above, the Web sites may be commerce sites in which visitors are engaged in some sort of on-line commerce, but the present invention is not restricted to use in connection with such sites. Hence, the Web pages may be associated with social networking sites, forums, blogs, content sites, etc. An e-commerce Website may be setup by merchant administrator 312 or a business owner or any other person interested in selling products and services online. Examples of e-commerce Websites include those operated by Amazon.com™, Overstock.com™ and E-bay.com™ However, it will be appreciated that present invention can be used with e-commerce Websites operated by small businesses or individuals selling products or services online. The e-commerce server 302 may include Web page applications, Web pages, and e-commerce software for facilitating transactions with consumers online, however, in some cases aspects of these services will be hosted on other servers. For example, payment services may be facilitated through servers operated by payment fulfillment providers. Such details are not critical to the present invention. In general it is sufficient for purposes of the present discussion to assume that the e-commerce server includes a Web server (or Web applications) for hosting the e-commerce Website's product Web pages. Usually, the e-commerce server 302 will also include or be associated with a merchant database 308 for storing customer and product information.

Also part of system 300 is an analytics system 208, hosting an analytics site which may be made up of a plurality of analytics pages 320n. The analytics pages 320n, some or all of which may comprise merchant user interfaces, are the means by which analytics information concerning visits to Web sites (e.g., e-commerce Website 406, shown in FIG. 4) is conveyed to merchant administrators. Such information may be stored by analytics system 208 in an analytics database 304 that is communicatively coupled to the analytics engine 218. In some cases, the analytics pages may be presented to a merchant administrator 312 via a Web browser running on a client computer system as individual pages. Or, the analytics information may be presented via a single analytics dashboard, which itself is styled as an analytics user interface. Often, some combination of these presentation mechanisms will be employed concurrently and so the particular user interface pages and layouts to be discussed below should be regarded only as examples of possible configurations and are not intended to limit the present invention unnecessarily.

The e-commerce Web sites 406 are accessed by users via client systems 314a-314c. The client systems may, in some cases, be computer systems, such as personal computers or the like, but more generally may be any computer-based or processor-based device that executes application software or embedded routines which allows the content of the Web site to be rendered for display to the user on a display device. For example, client systems may include computer systems, mobile devices such as iPads™, smart phones, mobile phones, etc., and the application software may be a Web browser 316 such as Microsoft Corporation's Internet Explorer™, Apple Inc.'s Safari™, or Google Inc.'s Chrome™, etc. Such applications are typically stored in one or more computer readable storage devices accessible to one or more processors of the subject client system and, when executed, cause the processor(s) to perform the operations necessary to render the subject sites/pages for display at the subject system (e.g., via a display device communicatively coupled to the processor).

The various constituents of system 300, including analytics system 208 and e-commerce server 302 are communicatively coupled to one another via one or more computer/data networks 310, which may include the Internet and other networks coupled thereto. The various computers, servers, routers, gateways, fiber optic cables, firewalls, wireless communication devices, radio towers and other networking devices which make up of network 310 and their precise hardware and software configurations is generally not critical to the present invention.

The analytics system 208 includes software and hardware for receiving communications from e-commerce server 302 and storing information in analytics system 208 and/or analytics database 304. The analytics system also communicates with merchant administrator 312 over network 310. The merchant administrator 312 may be a person using a desktop, laptop, server, mobile device or any other computing system that has sufficient computing resources to process and respond to information and instructions from analytics system 208. In other embodiments, the merchant administrator 312 may be an unmanned computer.

The analytics system 208 may store information on customers of or visitors to the e-commerce Website, such as products previously purchased, previous visits to the Website, pages accessed and viewed, and any other useful information on the customer such as product preferences, etc. This information may be stored in analytics database 304 and/or any other database including merchant database 308 for later data mining and customization of marketing instructions and promotions. The analytics system communicates real time information concerning these customers and visitors and their activities at the e-commerce Website, running on e-commerce server 302 to the merchant administrator 312. As discussed below, in some embodiments, this telemetry is facilitated via a cookie placed on the customer's/visitor's computer device.

As shown in FIG. 3, in one embodiment, e-commerce server 302 includes analytics software 322 which may be installed by a merchant administrator 312 or analytics system 208, or any other person, entity or computer system implementing the present invention. In one embodiment, the analytics software installed on e-commerce server allows the e-commerce server to communicate directly with and transmit information to and from analytics system 208, and also receive information from customer computers interfacing with the e-commerce system.

FIG. 3 also depicts clients 314a-c which are typically used by consumers visiting e-commerce Websites, such as e-commerce server 302. Clients 314a-c may consist of computing devices, such as a computer 314a (laptop or desktop), a smartphone 314b, or a tablet or other portable computing device 314c (such as the Apple i-pad™). Clients 314a-c are employed by various consumers who visit e-commerce Websites hosted by e-commerce server 302. As shown in this embodiment, the clients 314 include Web browser 316n (or other software) for visiting e-commerce Websites. The Web browsers used in embodiments of the invention may include, for example, Microsoft Explorer™, Fire Fox™, Netscape Navigator™, Apple Safari™ and Google Chrome™. The Web browsers may be configured to allow the receipt of cookies and/or other files for monitoring the activities of Web browsers 316 and/or clients 314a-c on e-commerce Websites. As shown and depicted in FIG. 3, the e-commerce server transmits Web pages 318n (such as product Web pages) to the Web browsers 316n.

In one embodiment, consumers or customers desiring to visit an e-commerce Website use clients 314 and Web browsers 316n to visit or log into e-commerce server 302 with e-commerce Website. In one embodiment, upon logging in, the e-commerce server 302 and/or analytics system 208 determine whether the customer has previously logged in or registered with the Website. If the customer is visiting the e-commerce server 302 for the first time, the analytics software 322 and/or other software or application on the e-commerce Website is notified of the new customer (which may be identified by its client Internet Protocol (IP) address, computer media access control (MAC) address, registration information, or other information) that identifies the client 314 as a new customer or visitor of the e-commerce Website. The customer information will be stored at the analytics system 208 and/or e-commerce server or merchant database 308. It will also be appreciated that each time a new customer or previous customer visits the e-commerce server the analytics system 208 receives notification of the customer activity.

In another embodiment of the invention, the analytics system 208 will receive information on the login of clients 314a-314c. For example, cookies, or other software may be installed or present on customer client devices that communicate directly with the analytics system to provide the merchant administrator real-time access to information on the customers visiting the e-commerce website 408.

According to one embodiment of the invention, if a new or previous customer is identified, e-commerce server, using analytics software 322, may transmit a cookie or (other monitoring file) to the client Web browser 316. The cookie or monitoring file is used to transmit information from client devices and/or Web browsers 316n to analytics system 208. The information transmitted includes the activities of the customer and the interactions of the customer with the e-commerce Website. For example, each time the consumer visits the c-commerce Website, views a product page, puts an item in a shopping cart, removes an item, purchases an item, or takes any other action on the e-commerce Website, such information is transmitted to the analytics system 208.

The consumer actions taken on e-commerce Website are sometimes referred to herein as “real-time consumer activity”. The real-time consumer activity from clients 314a-c or Web browsers 316n may be transmitted directly to the analytics system 208, for processing and display to merchant administrator 312, over the network 310, or alternatively transmitted to the e-commerce server and then routed to analytics system 208 by analytics software 322 or other applications on the e-commerce server that are in communication with analytics system 208, for eventual processing and display to the merchant administrator 312. According to one embodiment, each time a new visitor or customer enters an merchant's e-commerce Website, the analytics system is alerted through a notification. The notification may be electronic signal, message, data package or other form of computerized communication known to one of ordinary skill in the art. In this way, the analytics system can begin monitoring the customers activities on the Website for real-time reporting to the merchant administrator to be discussed in further detail below.

It will be appreciated that clients 314a-314c may have Web browsers 316n which may periodically or upon command delete cookies or other files received from the Internet. Accordingly, embodiments of the present invention allow the e-commerce server and/or analytics system 208 to transmit the cookie or monitoring file to the client 314 each time a consumer logs into the e-commerce server. This will ensure that the analytics system can receive information on the activities of consumers visiting the e-commerce Website. In other embodiments, the e-commerce Website may enable the use of cookies on the consumer's client device, depending on whether the use of cookies or other Internet files that transmit information over a network is enabled on the device. The commerce server and/or analytics software on the e-commerce server may also prompt the consumer to turn on cookies when the user visits the Website to ensure that the user can experience an optimal real-time online shopping experience and receive marketing and promotional information in real-time.

In other embodiments, it may not be necessary to employ a cookie or monitoring file for transmitting information to the e-commerce server 322 and/or analytics server 208. It is also possible that the consumer visiting an e-commerce server can register with the Website and obtain a user name/password for subsequent recognition by the e-commerce server upon login. In this situation, the analytics system can track the user's real time consumer activity through the login session with or without cookies being transmitted to the user's computer.

According to one embodiment, the merchant administrator 312 is also connected to the real-time e-commerce system by network 310. The merchant administrator may be a business owner, operator, employee or other person interested in viewing the activities of online customers and interacting with e-commerce customers in real time. In one embodiment, the merchant administrator 312 is the merchant who owns or operates the e-commerce Website hosted on e-commerce server 302. The merchant administrator may access the services of the analytics system 208 using any suitable computing devices with a network connection, such as desktop, laptop or mobile computing device connected to the Internet In one embodiment, the communications between the merchant administrator 312 and the analytics system 208 are bi-directional. The merchant administrator may log into the analytics system 208 using a unique user name and password provided by the analytics system. In one embodiment, the merchant administrator uses a Web browser to access the analytics system 208. In other embodiments, the merchant administrator may use an application residing on the merchant's computing device that communicates with the analytics system. The merchant administrator is able to monitor and track the activities of customers to the merchant's e-commerce Website through the analytics system 208, which as discussed above, receives real-time information on clients 314a-c that are visiting and interacting with e-commerce server 208.

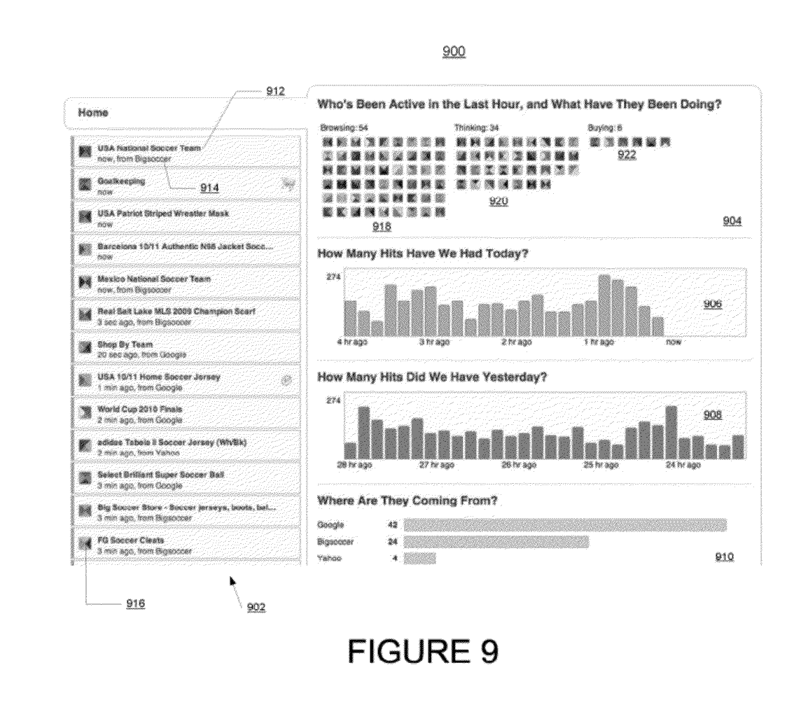

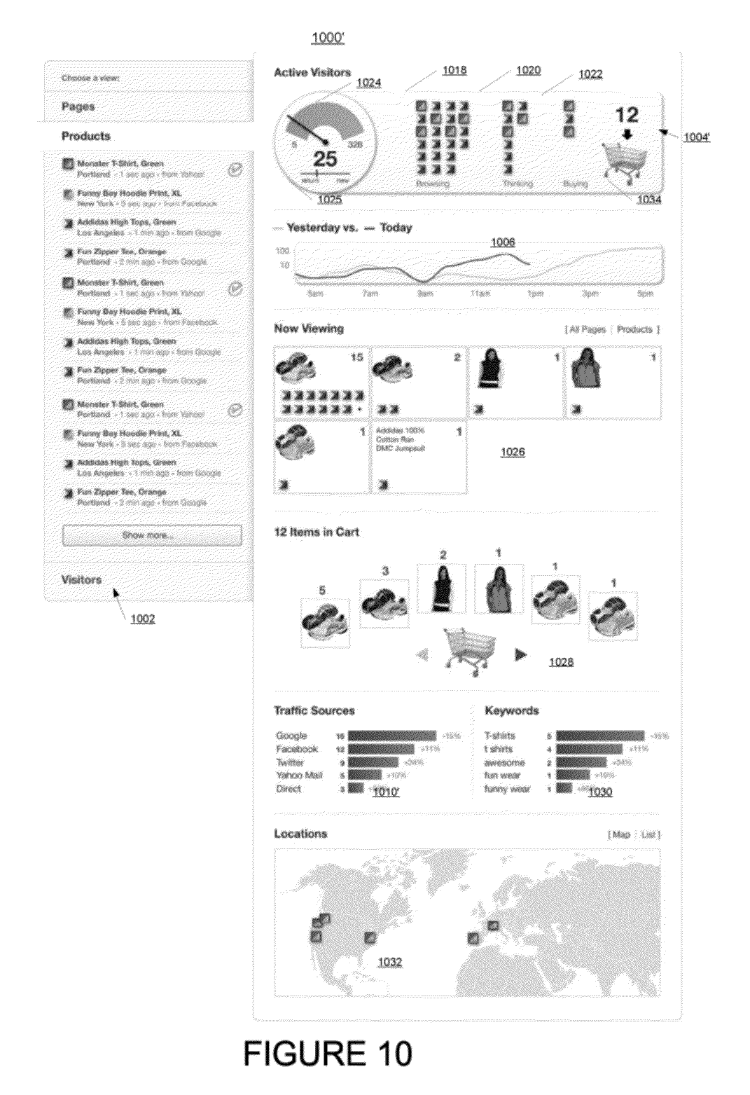

According to one embodiment, the analytics system 208 includes a merchant dashboard engine 220 (shown in FIG. 4) which provides the merchant administrator user interfaces for monitoring and viewing the real-time consumer activities of individuals (clients 314a-c). As shown in FIG. 3, the analytics system 208 provides analytics pages 320n to merchant administrator over the network. The analytics pages 320n (described in further detail in reference to FIGS. 9 and 10) include information such as the number/identity of customers currently visiting the e-commerce Website, the number/identify of customers currently “browsing” for products, the identity of the products which the customers are browsing, the number/identify of customers putting items into a virtual shopping cart, the number/identity of customers who have purchased products or services, and an identification of the products and services customers have purchased. In addition to receiving information from the analytics system for viewing real-time consumer activity, the merchant administrator 312 can also send commands and instructions to analytics system 208, such as defining rules for marketing and pricing product or bidding on search terms or advertisements in response to real-time consumer activity.

FIG. 4 shows an embodiment of the analytics system 208. The analytics system includes various software modules and databases for processing real-time consumer activity, including deal engine 212, rule engine 214, recommendation engine 216, analytics engine 218, analytics database 304, merchant dashboard 220, front end server 222, marketing engine 402 and game engine 514. In one embodiment, the analytics system 208 communicates with e-commerce Website 406, to provide real time information on customers visiting e-commerce Website. According to one embodiment, the e-commerce Website communicates with front end server. The front end server 222 may be a Web server or communications server for processing commands, instructions and data to and from analytics engine 218 or any other component of the analytics system 208. According to one embodiment of the invention, the front end server 222 may be responsible for all incoming and outgoing communications with e-commerce Website 406.

According to one embodiment, at the core of the analytics system 208 is the analytics engine 218. In one embodiment, the analytics engine is receives data and information from the e-commerce Website 406 and/or clients 314a-c, concerning the real time consumer activities occurring on an e-commerce Website. Real-time analytics information, including customer information is stored in analytics database 304. For example, when a customer visits e-commerce Website 406, the analytics engine will receive a notification or alert of the customer from the e-commerce Website. The analytics engine can use the information to determine whether the customer is a first time customer or a new customer and update the analytics database accordingly. The analytics engine can also check with the rule engine 214, deal engine 212 or the recommendation engine 216, to determine whether there are any rules, deals or recommendations that should be provided to the customer on the e-commerce Website for display on Web browsers 316n.

In one embodiment of the present invention, the analytics engine 218 is also a data mining center that is capable of receiving information from other Websites, databases and information centers in order to monitor general consumer trends or activity on the Internet. This information may be communicated to merchant administrator 312 via merchant dashboard engine 220. The merchant administrator then has the option of changing the offerings on e-commerce Website 406 in real-time in order to react to market and consumer trends.

According to one embodiment, the rule engine 214 includes instructions and data to define certain rules for e-commerce Website 406. For example, the rule engine may include instructions to change the price or offer a discount to customer if the customer buys a certain number of products from e-commerce Website or visits the Website a certain number of times. In other embodiments, the rule engine may contain rules to offer discounts on holidays or other occasions. Also, the rule engine may be dynamic in that it may adapt to trends or events. For example, a rule may be set to offer discounts on “team A” jerseys if team A wins the national championship of a sporting event. In this case, the rule engine would receive real-time feedback from the analytics engine 218 which is configured to receive information and mine data on events of interest such as sporting events, elections, concerts, news, and customer trends and consumer habits. The rule engine may also define whether recommendations should be made for certain products. The rule engine 214 communicates directly with the analytics engine 218, which processes the rules to determine whether to invoke a deal or recommendation from the deal engine 212 and recommendation engine 216.

According to one embodiment, the rule engine may be configured to monitor customer traffic, products browsed, or web pages visited in order to specifically market a product or change the price of a product in response to real time events.

According to one embodiment of the present invention, the deal engine 212 generates specific deals and promotions based on the rules or information received from the or rule engine 214 or analytics engine 218. The deal engine may generate a deal message 412, which may be any command or data instruction to be sent to the e-commerce Website 406, and subsequently displayed to visitors of e-commerce Website, such as clients 314a-c. The deal message 412 may be customized for a particular customer based on feedback from the analytics engine 218 and/or rule engine 214 such that a command may specify that certain deals and promotions be made available to repeat customers, new customers, or randomly selected customers.

It will also be appreciated that the merchant can customize deals as the merchant views the customer real-time consumer activity. This can be accomplished, for example, by specifying or changing the rules, or sending a command from the merchant dashboard engine 220 which will be relayed through the analytics system to the e-commerce Website 406. It should be noted however, that a deal can be generated in number of different ways, both manual and automatic according to present embodiments of the invention. The generation of deals in real-time is particularly advantageous to the merchant. For example, while the merchant monitors the traffic to his e-commerce Website, the merchant may notice a spike of activity and visitors on his site at a particular time of day. The merchant can react quickly to the increased traffic to his Website by instructing the deal engine to 212 to send a deal message 412 to all customers currently on the Website and further specify that the deal will expire in any given time period (e.g., in one hour) from the time it first appears on the e-commerce Website 406.

The following example, according to an embodiment of the invention, illustrates how a “deal” may be generated for a customer of an e-commerce Website. Consider an e-commerce Website that provides art, posters and prints. The e-commerce Website 406 is connected to the analytics system 208. The customer visits the e-commerce Website 406. The customer desires to buy prints for his office or home and is particularly interested in jazz album art covers. Based on the pages visited and the search terms entered by the customer of the e-commerce Website, the analytics engine 218 determines that the customer has a particular preference for classic jazz musicians Miles Davis and John Coltrane. In this example, if the customer puts more than 3 prints in his or her virtual shopping cart, a rule specified by the rule engine 214 may trigger a deal for “buy 3 prints and get one free”. In addition, the merchant, through the merchant dashboard engine 220, may see that the customer is interested in jazz, and in particular, Miles Davis and John Coltrane. Based on this real-time knowledge, the merchant may make an instant deal to the customer for a free John Coltrane album art print when the customer puts 3 or more items into his shopping cart. The merchant can accomplish this in any number of ways by using the merchant dashboard 220 to interact with the rule, engine, deal engine or analytics engine. Unlike conventional systems, this generation of customized and real-time deals can influence purchasing decisions in real-time.

In one embodiment, the recommendation engine 216 is also a part of the analytics system 208. The recommendation engine can generate recommendations, such as recommendation message 414, which includes a recommended product, service or related product that is based on the user's decision to purchase or tentatively purchase (by placing item in virtual shopping cart) a product or service from the e-commerce Website 406. The analytics engine 218 can receive feedback on the user's purchases or tentative purchase decisions and transmit this information to the recommendation engine 216 and/or the deal engine 212, to determine whether there is recommendation and/or deal available for the customer. For example, a customer purchasing a laptop may also be interested in laptop cases and/or hardware and software upgrades to the base model. In this case, the recommendation engine can make additional product recommendations or upgrades which will be generated and sent to the user of the e-commerce Website.

The analytics system may also include a game engine 514. The game engine can generate games on the e-commerce Website 406 that can be played by a customer using a Web browser or other appropriate software. The games may be used by the analytics system to award customers with points that can be accumulated and used for future visits to the Website and also to unlock deals that may be awarded to the customers upon use, completion or achievements. It will be appreciated that any suitable game that can operate on a Web page known to of ordinary skill in the art (e.g., using JavaScript) can be employed in the embodiment of the present invention. It will also be appreciated that the games on the website may consist of having the user visit certain pages or a click on certain icons in order to activate promotions. In a simple embodiment, the game may consist of having the consumer take certain steps on the e-commerce Website to unlock promotions and deals. For example, a deal or promotion may be unlocked when a consumer visits the most popular product pages, products on sale, or new products. These type of consumer interactions with the Web page may be provided to unlock special deals.

Marketing engine 402 may also be implemented in certain embodiments of the invention. The marketing engine is useful for marketing the merchant's e-commerce Website or other merchant promotions on the Internet. In one embodiment, as shown in FIG. 4, the marketing engine may bid on certain search terms with search term providers 404, such as Google™, Yahoo™, or Microsoft Bing™. The marketing engine may be configured to bid on terms based on rules specified by the rule engine 214 and data provided by the analytics engine 218. For example, consider the situation where “Team A” wins a national championship. If the merchant is in the business of providing sports apparel, the marketing engine, based on real time feedback from the analytics engine 218 and/or rule engine 214, will begin bidding for search terms such as team name, players names, franchise names, or jersey numbers of certain players to increase the overall presence of the merchant's e-commerce Website on the Internet when users search for sports apparel of “Team A”.

Another way in which the marketing engine can be used is based on real-time feedback to the merchant of activity on the merchant's e-commerce Website 406. For example, increased traffic on pages for Team A apparel or placement of Team A apparel in virtual shopping carts, can prompt the merchant to instruct the marketing engine 402 to begin bidding on search terms related to Team A. The ability to react to user trends and news in real time provides the merchant with an advantage over conventional e-commerce system. The market for search terms is very competitive and terms can be bid up very quickly in response to consumer trends or preferences. Accordingly, rather than relying on analytic Website data that is days or weeks old (historical data), embodiments of the present invention allow a merchant to make real-time decisions based on real-time data and capture an advantage over his competitors in both advertising and search term bidding. It should be noted that the marketing engine may include functionality for other uses, such as running Internet advertisements on certain Web pages, or requesting that certain advertisements for the e-commerce Website 406 be run on one or more relevant Websites. For example, in one embodiment, the marketing engine is configured to place ad requests to popular Websites such as ESPN.com or the Sports section of various national newspapers in response to real-time sports news. Based on real time analytics, the ad requests from marketing engine can seek advertisements for currently popular items such as Team A jersey or any other relevant items for a winning or popular team.

The rule engine in conjunction with the analytics engine may define when the marketing engine runs advertisements or purchases advertisements from various search engines. In this way, relevant and market driven advertisements can be used effectively. Consider the example where an e-commerce website normally receives about 10 users a day to a particular product web page. One day the activity for the product web page increases from 10 users a day to 100 users a day. The analytics engine registers the spike in activity for this product page and can react automatically. For example, the rule engine may be set such that a 100% increase in consumer activity to a particular product page can decrease the price of the product a certain percentage. For example if a product normally costs $50, user activity on that product page increases 100%, the rule engine may specify that the price of the product be reduced 20%, to $40. Also, if the activity on the product web page decreases back to its normal baseline value, the price can be automatically adjusted back to $50. In this way, a merchant is able to control the pricing and promotions of hundreds or even thousands of products in real time without the manual labor required to analyze data and react accordingly to making changes to the offerings on the e-commerce site.

In addition or alternatively, the rule engine 214 in conjunction with the analytics engine 218, can cause the marketing engine to display advertisements on the merchant's e-commerce website upon a threshold of activity be reached. In this case, when a particular product is browsed a number of times above the average rate, an advertisement on the main page may display this product as the “featured product” and offer a discounted price for that product.

In other embodiments, the marketing engine may request ads be displayed on other websites in response to activity on the e-commerce Website 406. Upon a certain threshold of interest or purchasing activity being reached, the marketing engine, might, for example, request that a “sale on Team A jersey” ad be run on various Websites. This may be accomplished automatically by the generation of an e-mail message or other electronic communication over the network to the relevant advertising agency, Website operator or search engine. It will also be appreciated that the ad to be run on other websites can be placed automatically on the site directly without any interaction with a person or third party. For example, Websites such as Yahoo™ have application programming interfaces (APIs) that allow merchants to place an ad automatically on Yahoo websites. Thus, it is contemplated that the marketing engine 402 can interact directly with other Websites or search engines to have ads placed automatically upon a certain rule being satisfied.

According to one embodiment, the merchant dashboard 220 is incorporated into analytics system 208 as shown in FIG. 4. The merchant dashboard engine presents real-time analytics information to the merchant connected to the analytics system. The merchant dashboard engine 220 receives real-time analytics information from the analytics engine 218 and creates interactive user interfaces for the merchant administrator. Examples of user interfaces generated by the merchant dashboard engine are shown in FIGS. 9 and 10. The merchant dashboard can generate, among other things, a display, in real-time of the number and identify of customers visiting e-commerce Website 406 and the number of customers actively browsing or purchasing items from the Website. The merchant dashboard may also generate graphs, charts and live icons that represent real-time consumer activity. It will also be appreciated that the merchant dashboard is configured to receive communications and commands from merchant administrator 312 over the network. The merchant administrator may specify or change rules, create deals and promotions, or provide instructions to the marketing engine 402.

FIG. 5 depicts a system for generating advertisements 522 and/or bidding on search terms with search term providers 516-520 based on real-time consumer activity. In this embodiment, the analytics system 208 constituents, the analytics engine 218, rule engine 214 and marketing engine 402 are shown. A merchant administrator 312 is communicatively coupled to the analytics system. As discussed previously, the analytics system 208 is also communicatively coupled to the e-commerce website 406. Customers 502-506 are shown logged into to e-commerce website 406 where they may be browsing or purchasing products. Also shown here, are search term providers 516-520, each corresponding to a different search term engine or search term provider such as Yahoo™, Google™, and Microsoft Bing™ The marketing engine is able to bid on search terms or advertisements automatically with one or more of search term providers 518-520 when at least one rule is satisfied. Also, as shown here, the marketing engine 402 can generate an ad 522 based on real-time consumer activity. For example, the analytics engine 218 may register consumer activity reaching a certain threshold. If this threshold satisfies a particular rule, a an ad 522 is generated. Alternatively, the merchant administrator can bid on search terms or place ads through interaction with the analytics system 208. The merchant administrator is able to monitor the activities of customers 502-506 and the web pages 318n being accessed by such customers. Using the system depicted in FIG. 5, the merchant administrator can make real-time decisions on whether the change the products, pricing or advertising on e-commerce website 408.

It will be appreciated that ads can be generated manually or automatically depending on the configurations set by the administrator of the system. The ads displayed to the customer can be sent in any number of ways, including a Web based message, email, instant message or even phone message. The analytics system may be configured to adapt any number of network communication means to display advertising to the customer.

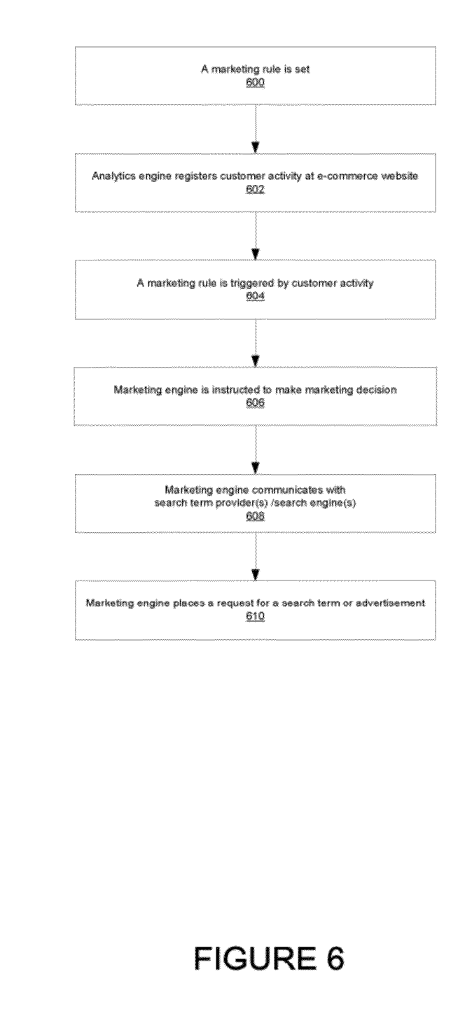

FIG. 6 is a flow diagram showing a real-time e-commerce marketing method according to one embodiment of the invention. In step 600, a marketing rule is set. This rule can be set by the administrator or by the analytics engine, rule engine or both. In step 602, the analytics engine registers customer activity at the e-commerce website. Customer activity, may consist of, for example, the number of customers on the e-commerce site, the number of customers actively browsing product web pages, or the number of customer putting items in a shopping basket, etc. In step 604, the marketing rule is triggered by customer activity. The rule may be any value registered by the analytics engine that instructs the marketing engine to take some action. A rule that specifies that a 500% increase in product web page viewing should result in search terms for the product being purchased, is one example of a marketing rule. In step 606, the marketing engine is engaged to make a marketing decision based on activation of the rule. In step 608, the marketing engine communicates with one or more search term providers or search engines. In step 610, the marketing engine places a request for a search term or advertisement.

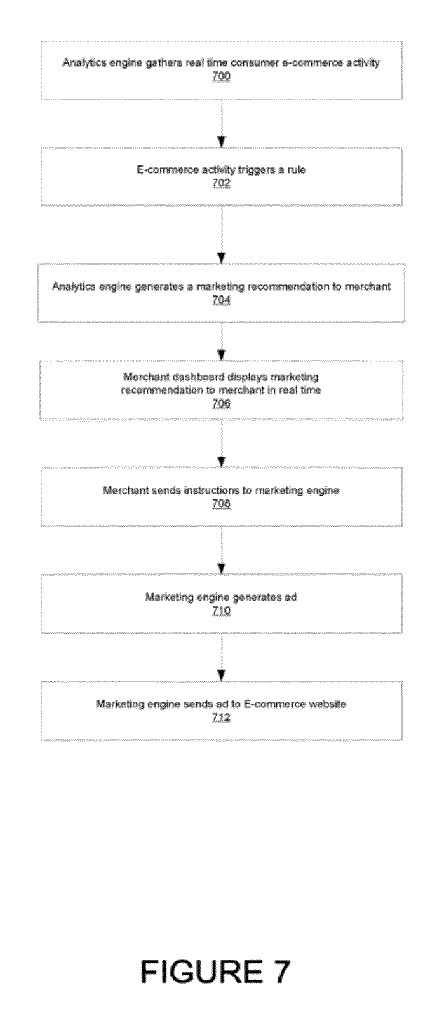

FIG. 7 depicts a flow diagram of a semi-automated method for generating an advertisement according to one embodiment of the invention. In step 700, the analytics engine gathers real-time consumer e-commerce activity. As discussed previously, this may correspond to data on the number of pages visiting, the number of customers, the products viewed and/or purchased items, etc. In step 702, the e-commerce consumer activity triggers a rule. The rule may be triggered at the rule engine or analytics engine, or both. It should be appreciated that the rule can be triggered at one or more software modules in analytics system 208. Once the rule is active, the analytics engine communicates with the merchant administrator, making a marketing recommendation in real-time. The marketing recommendation may originate from the analytics engine, the marketing engine, or both. Again, the origin of the marketing recommendation is not important as it can originate from one or more software modules in analytics system 208. The marketing recommendation is sent to the merchant administrator via the merchant dashboard who can view the marketing recommendation on a web page, or receive a notification by email or SMS message or any other form of instantaneous communication means. Based on the marketing recommendation, the merchant can decide what type of marketing to engage in. In step 708, the merchant sends instructions to the marketing engine. This may be a request to bid on search terms, generate an advertisement, etc. In step 710, the marketing engine generates an advertisement. In step 712, the marketing engine sends the ad to the e-commerce website where it is then visible to consumers.

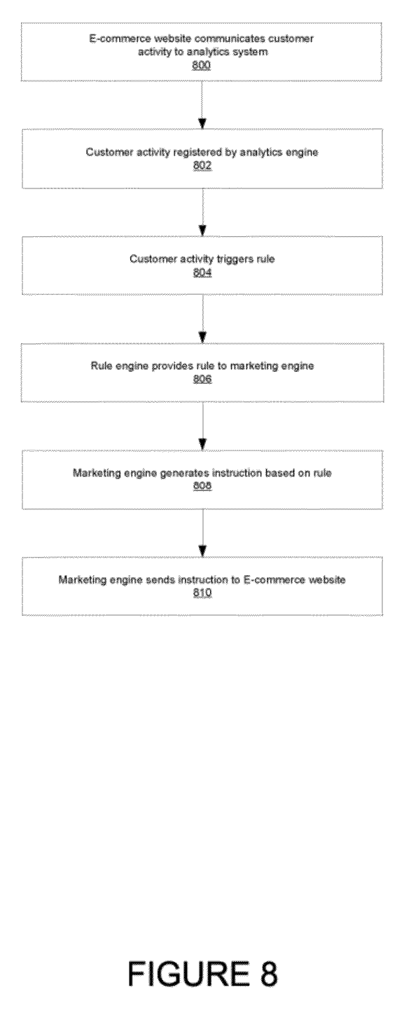

FIG. 8 shows an automated method for generating an advertisement, instruction or other message on an e-commerce website. In step 800 the e-commerce website communicates customer activity to the analytics system. In step 802, the customer activity is registered by the analytics engine. In step 804, a rule is triggered based on the customer activity. In step 806, the rule is communicated to the marketing engine. In step 808, the marketing engine generates an instruction based on the rule. In step 810 the marketing engine sends an instruction to the e-commerce website. The instruction may include, for example, a command to display an advertisement, to change the price of a product, or to offer a promotion or deal.

Turning now to FIG. 9, a first example of a user interface 900 adapted to allow a merchant administrator 312 to view real time information concerning activities of visitors to the subject Web site is presented. As discussed earlier, in one embodiment, the real-time analytics user interfaces are generated by the merchant dashboard engine 220. User interface 900 may be delivered in the form of a Web page, such as analytics page 320n, by a server, such as analytics system 208, to a Web site administrator client, such as merchant administrator 312, and rendered on a display thereof in a Web browser. Included in user interface 900 are various fields, including a visitor field 902, an activity field 904, and various history fields 906, 908, 910. Visitor field 902 includes, for each visitor to the subject Web site, identifying information of the visitor 912, which may be a visitor name or other identifying information received from the clients 314a-c associated with the visitor to the subject Web site, an indication of when the visitor is/was active on the subject e-commerce Website 406 (and in some cases this may include information identifying where the visitor arrived at the subject Web site from), and a jewel or other graphical element or icon 916.

The jewels 916 associated with the visitors are used in connection with the activity field 904 and may be grouped into various activity groups 918, 920, 922. Of course, these are merely examples of activity groups and in various embodiments, more or fewer activity groups may be used. In this example, activity group 918 identifies visitors to the site that are deemed to be “just browsing”. Activity group 920 identifies those users considered to be “thinking” about making purchases. Activity group 922 identifies those users who are actually “buying” products for sale at the subject Web site. The associated visitor jewels are placed in the various activity groups by the analytics server according to the actual visitor behavior at the subject Web site. For example, “browsing” users may be those who recently arrived at the site, and/or those who do not manifest significant dwell time on any particular product pages. Those users who do linger on particular product pages for at least a specified time interval may be classified as “thinking” about purchase decisions and so their associated jewels may be moved from the browsing activity group to the thinking activity group. For visitors that have actually placed products in a virtual shopping cart or otherwise manifest a purchasing decision or intent, their associated jewels may be moved into the buying activity group. Regardless of the classifications and/or number of activity groups, the important thing to notice is that the classifications of the various visitors to the subject Web site for which user interface 400 is providing analytical information is that the information is being delivered in real time to the Web site administrator and so is available for real time use by that administrator.

The information itself that is used to produce the analytical information may be derived from real time information collected by the analytics system 208 from the various visitor client machines 314a-c. When a visitor first reaches the subject Web site with their browser, the Web site delivers a cookie to the browser. The cookie includes a script that causes the browser to report certain information to the analytics system, where the information is logged and stored in database 304. The stored information can then be analyzed to provide the real time feedback exemplified in user interface 900. The use of cookies allows for unique visitor identification and tracking even where IP addresses are shared by groups of users or proxies. Nevertheless, in alternative embodiments, JavaScript on each page of the subject Web site could be used to notify the analytics system when a page is rendered by a visitor's Web browser. Both methods collect data that can be processed to produce the information described herein.

The history fields may include a recent history field 906, a past history field 908 and a referral field 910. The recent history field 906 may include information regarding recent visitors to the subject Web site. For example, in the illustration shown in FIG. 9, the recent history field shows the number of visitors to the subject Web site during the present day in running periods of quarter-hours, with the data represented in a histogram. Of course, other representations and/or statistics regarding recent visitors may be presented in lieu of or in addition to this visitor number data.

The past history field 908 may include information regarding past visitors to the subject Web site. For example, in the illustration shown in FIG. 9, the past history field shows the number of visitors to the subject Web site over the past day or so in running periods of quarter-hours, with the data represented in a histogram. Of course, other representations and/or statistics regarding recent visitors may be presented in lieu of or in addition to this visitor number data.

The referral field 910 provides real time information concerning Web locations where visitors to the Web site are originating from. This may include referrals from search engine search result pages, from direct entries of Web site URLs into browser address fields, and/or other referral pages. By understanding where current visitors to the site are originating from, the Web site administrator is provided a powerful tool to direct current advertising and/or marketing resources in order to reach the greatest number of potential customers and/or to allocate limited funds.

FIG. 10 illustrate further examples of user interfaces adapted to allow merchant administrators to view real time information concerning activities of visitors to the subject Web site. In FIG. 10, user interface 1000′ includes the visitor field 1002, with visitors associated with identifying jewels, and the various activity groups 1018, 1020, 1022. In this example, however, the activity field 1004′ includes additional items, including a gauge 1024 that shows the number of current active visitors and an indication of the relative number of new visitors to the number of repeat visitors (see the slider 1025 at the bottom of gauge 1024). The gauge may be configured to flash or adopt other visual indications when new visitors arrive at the Web site and/or existing visitors leave the subject Web site. Also, the activity field 1004′ includes a new shopping cart indicator 1034 where, for a selected visitor, the number of items being purchased is represented as being present in the visitor's virtual shopping cart. The actual items so included in the shopping cart can be viewed in a purchasing field 1028 elsewhere on the page. In this example, graphical representations representing the items being purchased (e.g., images of the products from the subject Web page) are shown as being included in the user's shopping cart and the administrator can scroll to see which items are so included in the cart.

Another new field in user interface 1000′ is a product view field 1026. In this field, real time information concerning which visitors are browsing which products is displayed. Notice that the jewels representing the visitors are arranged so as to be associated with the current product which the visitor is viewing in his/her Web browser. In addition, a total number of visitors viewing the subject product is provided.

The referral field 1010′ again provides real time information concerning Web locations where visitors to the Web site are originating from and this time an associated keywords field 1030 is provided as well. Keywords field 1030 reports (e.g., using histograms, bar charts or other indicators) which keywords used in search engine queries are driving various numbers of visitors to the Subject Web site. This information can assist an administrator in making keyword purchase decisions. Further, a map 1032 illustrates in a highly intuitive fashion where the current Web site visitors are originating from.

In this example, the history field 1006′ has been organized as a graph showing relative numbers of visitors over selected time periods (e.g., yesterday vs. today). Of course, other visitor number informational display means could be used.

Of course, many other informational representations may be provided in various configurations of the presents user interfaces and the foregoing examples should not be read as limiting the present invention. In some instances, user classifications may be associated with the users, for example to indicate status as a loyal customer (e.g., one that makes frequent purchases), a discount customer (e.g., one that makes purchases only of sale items), an impulse buyer (e.g., one that adds items to shopping carts within a short period of time after arriving at the subject Web site), a needs-based buyer (e.g., one that arrived at the Web site though a specific keyword search and added the specified product to a shopping cart), and a wandering visitor (e.g., one that spent time viewing a number of different pages, but made no purchases).

As should be apparent from the foregoing discussion, various embodiments of the present invention may be implemented with the aid of computer-implemented processes or methods (i.e., computer programs or routines) or on any programmable or dedicated hardware implementing digital logic. Such processes may be rendered in any computer language including, without limitation, a object oriented programming language, assembly language, markup languages, and the like, as well as object-oriented environments such as the Common Object Request Broker Architecture (CORBA), Java™ and the like, or on any programmable logic hardware like CPLD, FPGA and the like.

It should also be appreciated that the portions of this detailed description that are presented in terms of computer-implemented processes and symbolic representations of operations on data within a computer memory are in fact the preferred means used by those skilled in the computer science arts to most effectively convey the substance of their work to others skilled in the art. In all instances, the processes performed by the computer system are those requiring physical manipulations of physical quantities. The computer-implemented processes are usually, though not necessarily, embodied the form of electrical or magnetic information (e.g., bits) that is stored (e.g., on computer-readable storage media), transferred (e.g., via wired or wireless communication links), combined, compared and otherwise manipulated. It has proven convenient at times, principally for reasons of common usage, to refer to these signals as bits, values, elements, symbols, keys, numbers or the like. It should be borne in mind, however, that all of these and similar terms are to be associated with the appropriate physical quantities and are merely convenient labels applied to these quantities.

Unless specifically stated otherwise, it should be appreciated that the use of terms such as processing, computing, calculating, determining, displaying or the like, refer to the action and processes of a computer system, or similar electronic computing device, that manipulates and transforms data represented as physical (electronic) quantities within the computer system's registers, memories and other storage media into other data similarly represented as physical quantities within the computer system memories, registers or other storage media. Embodiments of the present invention can be implemented with apparatus to perform the operations described herein. Such apparatus may be specially constructed for the required purposes, or may be appropriately programmed, or selectively activated or reconfigured by a computer-readable instructions stored in or on computer-readable storage media (such as, but not limited to, any type of disk including floppy disks, optical disks, hard disks, CD-ROMs, and magnetic-optical disks, or read-only memories (ROMs), random access memories (RAMs), erasable ROMs (EPROMs), electrically erasable ROMs (EEPROMs), magnetic or optical cards, or any type of media suitable for storing computer-readable instructions) to perform the operations. Of course, the processes presented herein are not restricted to implementation through computer-readable instructions and can be implemented in appropriate circuitry, such as that instantiated in an application specific integrated circuit (ASIC), a programmed field programmable gate array (FPGA), or the like.

It should be appreciated that the embodiments described above are cited by way of example, and that the present invention is not limited to what has been particularly shown and described hereinabove. Rather, the present invention includes both combinations and subcombinations of the various features described hereinabove, as well as variations and modifications thereof which would occur to persons skilled in the art upon reading the foregoing description and which are not disclosed in the prior art.

What is claimed is:

1. A real-time marketing system, comprising:
an analytics engine for processing e-commerce information;
a rule engine for generating one or more rules based on e-commerce information;
a marketing engine communicatively coupled to network, wherein said marketing engine is capable of generating a marketing instruction based on the triggering of a rule in response to real-time e-commerce information;
a merchant dashboard for generating real-time user interfaces;

2. The system of claim 1, wherein the marketing engine is communicatively coupled to a search engine.

3. The system of claim 2, wherein the marketing instruction comprises an instruction to bid on a search term.

4. The system of claim 3, wherein the marketing instruction comprises an instruction to display an advertisement.

5. The system of claim 4, wherein the advertisement is placed on an e-commerce website.

6. The system of claim 1, wherein said marketing instruction is an instruction to adjust a product price on an e-commerce website.

7. A method for real-time marketing in an e-commerce network, comprising:
setting a marketing rule to be triggered by market activity;
receiving and analyzing market activity;
automatically triggering a marketing rule based on market activity;
generating a marketing instruction based on the triggering of said marketing rule, wherein said marketing instruction is capable of effecting the marketing of an item.

8. The method of claim 7, further comprising the step of sending the marketing instruction to a search term provider, wherein said marketing instruction comprises a bid on a search term.

9. The method of claim 7, further comprising the step of sending the marketing instruction to an search engine to display an advertisement on one or more web pages associated with a search engine.

10. The method of claim 7, further comprising the step of sending the marketing instruction to an e-commerce website, wherein said marketing instruction comprises an instruction to display an advertisement on said e-commerce website.

11. The method of claim 7, further comprising the step of sending the marketing instruction to an e-commerce website, wherein said marketing instruction comprises an instruction to adjust the price of said item.

12. The method of claim 7, wherein said marketing instruction comprises a marketing recommendation to a merchant.

13. The method of claim 12, further comprising the step of receiving a marketing command from a merchant in response to said marketing recommendation.
